(19) United States
(12) Patent Application Publication
(10) Pub. No.: US 2026/0365036 A1
(43) Pub. Date: Nov. 19, 2026

(54) Rail-Guided Transport Vehicle, Control Method And Apparatus

(71) Applicant: Siemens Aktiengesellschaft, München (DE)

(72) Inventors: Zhen Jiang Yang, Beijing (CN); Kang Li, Jinan (CN); Xue Yuan Xu, Beijing (CN)

(73) Assignee: Siemens Aktiengesellschaft, München (DE)

(21) Appl. No.: 19/142,576

(22) PCT Filed: Dec. 23, 2022
(86) PCT No.: PCT/CN2022/141559

§ 371 Date: Jun. 23, 2025

(51) Int. Cl. B60L 15/20

(52) U.S. Cl. CPC B60L 15/2036; B60L 2200/26

(57) ABSTRACT

Various embodiments of the teachings herein include a control method for a rail-guided transport vehicle with a first group of drive control units including a first drive shaft and a first driven shaft corresponding to a first guide rail, and a second drive shaft and a second driven shaft corresponding to a second guide rail. An example includes: setting the first drive shaft and the second drive shaft to synchronize their positions with a position of a virtual main axis of the first drive shaft and the second drive shaft; obtaining a third torque difference between the first drive shaft and the second drive shaft; and rectifying, when the third torque difference is greater than a preset torque threshold, a deflection of the first drive shaft or the second drive shaft.

### CROSS-REFERENCE TO RELATED APPLICATIONS

This application is a U.S. National Stage Application of International Application No. PCT/CN2022/141559 filed Dec. 23, 2022, which designates the United States of America, the contents of which are hereby incorporated by reference in their entirety.

### TECHNICAL FIELD

The present disclosure relates to industrial control. Various embodiments of the teachings herein include rail-guided transport vehicles, control methods, and control apparatus.

### BACKGROUND

Corresponding to guide rails on both sides of a rail-guided transport vehicle, a drive shaft and a driven shaft are provided on each side of the rail-guided transport vehicle. When the drive shafts on both sides travel at different speeds, deflection of the vehicle body with respect to the rails is caused. To avoid this problem, position synchronization control is executed between the two drive shafts on both sides. However, absolute parallel between the vehicle body and the rails cannot be achieved in reality. For the rail-guided transport vehicles that travel a short distance, even if there is a slight deflection between the vehicle body and the rails, a large friction between the vehicle body and the rails will not be caused during its travel. Nonetheless, for the rail-guided transport vehicles that travel a long distance, even if there is a slight deflection between the vehicle body and the rails, after both sides travel synchronously for more than a certain distance, there will be a large friction between the vehicle body and the rails, which will stop the transport vehicle from continuing to move forward.

For a small-span transport vehicle, only very small vehicle body deformation is caused by frequent vehicle body deflection rectification by virtue of the relatively high rigidity of the small-span transport vehicle. For a long-span transport vehicle which has a relatively low rigidity, however, much deflection rectification should be avoided so that damage to the vehicle body is not caused by frequent vehicle body deflection rectification.

### SUMMARY

In view of this, teachings of the present disclosure provide a rail-guided transport vehicle, a control method and a control apparatus thereof and a computer-readable storage medium, thereby achieving vehicle body deflection rectification of a large-span and long-distance transport vehicle. For example, some embodiments include a control method of a rail-guided transport vehicle, the rail-guided transport vehicle comprising a first group of drive control units, the first group of drive control units comprising: a first drive shaft and a first driven shaft corresponding to a first guide rail, and a second drive shaft and a second driven shaft corresponding to a second guide rail, the method comprising: setting the first drive shaft and the second drive shaft to synchronize their positions with a position of a virtual main axis of the first drive shaft and the second drive shaft (S1); obtaining a third torque difference between the first drive shaft and the second drive shaft (S2); and rectifying, when the third torque difference is greater than a preset torque threshold, a deflection of the first drive shaft or the second drive shaft (S3).

In some embodiments, the rectifying, when the third torque difference is greater than the preset torque threshold, the deflection of the first drive shaft or the second drive shaft (S3) comprises determining a direction for deflection rectification based on a positive/negative value of the third torque difference.

In some embodiments, the preset torque threshold is obtained based on a variation curve of the third torque difference when a vehicle body of the rail-guided transport vehicle is not parallel to the first guide rail or the second guide rail.

In some embodiments, the rectifying the deflection of the first drive shaft or the second drive shaft (S3) comprises rectifying the position of the first drive shaft or the second drive shaft using a superimposed motion instruction, wherein the superimposed motion instruction is an instruction in a second coordinate system, and the second coordinate system is independent of a first coordinate system of the first drive shaft and the second drive shaft.

In some embodiments, when the number of deflection rectifications performed in accordance with the superimposed motion instruction within a preset time interval exceeds a number threshold of deflection rectifications, a position rectification range corresponding to the superimposed motion instruction is decreased.

In some embodiments, the method further comprises: configuring the actual position values of the first driven shaft and the second driven shaft as their set position values (S4); and setting a speed value of the first driven shaft and a speed value of the second driven shaft based on a speed value of the first drive shaft and a speed value of the second drive shaft (S5).

In some embodiments, the setting the speed value of the first driven shaft and the speed value of the second driven shaft based on the speed value of the first drive shaft and the speed value of the second drive shaft (S5) comprises: computing a first torque difference between the first driven shaft and the first drive shaft (S51); computing a second torque difference between the second driven shaft and the second drive shaft (S52); obtaining an additional speed value of the first driven shaft and an additional speed value of the second driven shaft based on the first torque difference and the second torque difference (S53); and obtaining the speed value of the first driven shaft and the speed value of the second driven shaft respectively based on the speed value of the first drive shaft, the speed value of the second drive shaft, the additional speed value of the first driven shaft, and the additional speed value of the second driven shaft (S54).

In some embodiments, the obtaining the additional speed value of the first driven shaft and the additional speed value of the second driven shaft based on the first torque difference and the second torque difference (S53) comprises adding a tension torque to the first torque difference or the second torque difference to obtain the additional speed value of the first driven shaft and the additional speed value of the second driven shaft.

In some embodiments, the rail-guided transport vehicle further comprises a second group of drive control units identical to the first group of drive control units, the method further comprising selecting the first group of drive control units or the second group of drive control units to perform drive control of the rail-guided transport vehicle.

As another example, some embodiments include a control device of a rail-guided transport vehicle, comprising: a first group of drive control units, the first group of drive control units comprising: a first drive shaft and a first driven shaft corresponding to a first guide rail, and a second drive shaft and a second driven shaft corresponding to a second guide rail, the first group of drive control units controlling the rail-guided transport vehicle based on one or more of the control methods described herein.

In some embodiments, the control device further comprises a second group of drive control units identical to the first group of drive control units, and the second group of drive control units are backup of the first group of drive control units.

As another example, some embodiments include a rail-guided transport vehicle, comprising: a first group of drive control units, the first group of drive control units comprising: a first drive shaft and a first driven shaft corresponding to a first guide rail, and a second drive shaft and a second driven shaft corresponding to a second guide rail, the first group of drive control units controlling the rail-guided transport vehicle based on one or more of the control methods described herein.

In some embodiments, the rail-guided transport vehicle further comprises a second group of drive control units identical to the first group of drive control units, and the second group of drive control units are backup of the first group of drive control units.

As another example, some embodiments include a computer program product stored on a readable medium of a controller, and comprising computer executable instructions, wherein the computer executable instructions, when executed, cause at least one processor to execute one or more of the methods described herein.

As another example, some embodiments include a non-transitory computer readable medium storing computer executable instructions thereon, wherein the computer executable instructions, when executed, cause at least one processor to execute one or more of the methods described herein.

### BRIEF DESCRIPTION OF THE DRAWINGS

To more clearly discuss the technical solutions in embodiments of the present disclosure or the prior art, the accompany drawings to be used in the description of the embodiments or the prior art will be briefly introduced below. Apparently, the accompanying drawings in the description below are merely some embodiments disclosed in the embodiments of the present disclosure. For those of ordinary skills in the art, other drawings may also be obtained based on these drawings.

FIG. 1 is a schematic diagram of an example rail-guided transport vehicle incorporating teachings of the present disclosure;

FIG. 2 is a step flowchart of an example control method of a rail-guided transport vehicle incorporating teachings of the present disclosure;

FIG. 3 is a schematic control diagram of an example first drive shaft and a second drive shaft of a rail-guided transport vehicle incorporating teachings of the present disclosure;

FIG. 4 is another step flowchart of an example control method of a rail-guided transport vehicle incorporating teachings of the present disclosure;

FIG. 5 is a schematic control diagram of an example first drive shaft and a first driven shaft of a rail-guided transport vehicle incorporating teachings of the present disclosure;

FIG. 6 is a step flowchart of step S5 of an example control method of a rail-guided transport vehicle incorporating teachings of the present disclosure;

FIG. 7 is still another step flowchart of an example control method of a rail-guided transport vehicle incorporating teachings of the present disclosure.

### REFERENCE NUMERALS IN THE FIGURES

1: First group of drive control units;
11: First drive shaft;
111: First position controller;
112: First speed controller;
113: First current controller;
114: First converter;
115: First motor;
12: First driven shaft;
121: Second position controller;
122: Second speed controller;
123: Second current controller;
124: Second converter;
125: Second motor;
13: Second drive shaft;
131: Third position controller;
132: Third speed controller;
133: Third current controller;
134: Third converter;
135: Third motor;
14: Second driven shaft.
S1: setting a first drive shaft and a second drive shaft to synchronize their positions with a position of a virtual main axis of the first drive shaft and the second drive shaft.
S2: obtaining a third torque difference between the first drive shaft and the second drive shaft.
S3: rectifying, when the third torque difference is greater than a preset torque threshold, a deflection of the first drive shaft or the second drive shaft.
S4: configuring the actual position values of the first driven shaft and the second driven shaft as their set position values.
S5: setting a speed value of the first driven shaft and a speed value of the second driven shaft based on a speed value of the first drive shaft and a speed value of the second drive shaft.
S51: computing a first torque difference between the first driven shaft and the first drive shaft.
S52: computing a second torque difference between the second driven shaft and the second drive shaft.
S53: obtaining an additional speed value of the first driven shaft and an additional speed value of the second driven shaft based on the first torque difference and the second torque difference.
S54: obtaining the speed value of the first driven shaft and the speed value of the second driven shaft respectively based on the speed value of the first drive shaft, the speed value of the second drive shaft, the additional speed value of the first driven shaft, and the additional speed value of the second driven shaft.
S6: selecting the first group of drive control units or the second group of drive control units to perform drive control.

### DETAILED DESCRIPTION

Some example embodiments of the teachings herein include a control method of a rail-guided transport vehicle. The rail-guided transport vehicle includes a first group of drive control units, the first group of drive control units include: a first drive shaft and a first driven shaft corresponding to a first guide rail, and a second drive shaft and a second driven shaft corresponding to a second guide rail. The method includes: setting the first drive shaft and the second drive shaft to synchronize their positions with a position of a virtual main axis of the first drive shaft and the second drive shaft; obtaining a third torque difference between the first drive shaft and the second drive shaft; and rectifying, when the third torque difference is greater than a preset torque threshold, a deflection of the first drive shaft or the second drive shaft.

In some embodiments, both the first drive shaft and the second drive shaft are set to be synchronized with their virtual main axis, thereby reducing the vehicle body deflection rectification caused by asynchronization between the first drive shaft and the second drive shaft. Only when the third torque difference between the first drive shaft and the second drive shaft is greater than the preset torque threshold, is the deflection of the first drive shaft or the second drive shaft rectified. In this manner erroneous deflection rectification resulted from the non-uniform distribution of loads is avoided.

In some embodiments, the rectifying, when the third torque difference is greater than the preset torque threshold, the deflection of the first drive shaft or the second drive shaft includes determining a direction for deflection rectification based on a positive/negative value of the third torque difference. Whether the first drive shaft or the second drive shaft has a larger torque may be determined based on the positive/negative value of the third torque difference, thereby determining whether the direction for the vehicle body deflection rectification is towards the first drive shaft or the second drive shaft and further improving the accuracy of the vehicle body deflection rectification.

In some embodiments, the preset torque threshold is obtained based on a variation curve of the third torque difference when the vehicle body of the rail-guided transport vehicle is not parallel to the first guide rail or the second guide rail. The preset torque threshold is obtained based on the variation curve of the third torque difference when the vehicle body of the rail-guided transport vehicle is not parallel to the first guide rail or the second guide rail, such that the preset torque threshold can satisfy the deflection rectification of the vehicle body in time without frequent deflection rectification of the vehicle body.

In some embodiments, the rectifying the deflection of the first drive shaft or the second drive shaft includes: rectifying the position of the first drive shaft or the second drive shaft using a superimposed motion instruction, where the superimposed motion instruction is an instruction in a second coordinate system, and the second coordinate system is independent of a first coordinate system of the first drive shaft and the second drive shaft. The rectification of the position of the first drive shaft or the second drive shaft in the first coordinate system of the first drive shaft and the second drive shaft will change the position of the first drive shaft or the second drive shaft, thereby resulting in a reverse rectification of the position of the first drive shaft or the second drive shaft. Therefore, in order to avoid the generation of a position to be reversely rectified, in the embodiment of the present disclosure, a speed value of the first driven shaft and a speed value of the second driven shaft are adjusted using the superimposed motion instruction in the second coordinate system independent of the first coordinate system of the first drive shaft and the second drive shaft. The second coordinate system is independent of the first coordinate system, and will not interfere with a motion behavior in the first coordinate system.

In some embodiments, when the number of deflection rectifications performed in accordance with the superimposed motion instruction within a preset time interval exceeds a number threshold of deflection rectifications, a position rectification range corresponding to the superimposed motion instruction is decreased. Since repeated deflection rectification of the vehicle body will cause the vehicle body deformation, in the embodiment of the present disclosure, when the number of deflection rectifications within the preset time interval exceeds the number threshold of deflection rectifications, the position rectification range corresponding to the superimposed motion instruction is decreased, thereby avoiding excessive deflection rectification caused by excessive position rectification range corresponding to the superimposed motion instruction.

In some embodiments, the method further includes: configuring the actual position values of the first driven shaft and the second driven shaft as their set position values; and setting the speed value of the first driven shaft and the speed value of the second driven shaft based on a speed value of the first drive shaft and a speed value of the second drive shaft. The actual position values of the first driven shaft and the second driven shaft are configured as their set position values so that the position controllers of the first driven shaft and the second driven shaft actually do not work. Thus, the first driven shaft and the second driven shaft operate in a speed control mode. The set speed values of the first driven shaft and the second driven shaft may be the set speed values of the first drive shaft and the second drive shaft respectively.

In some embodiments, the setting the speed value of the first driven shaft and the speed value of the second driven shaft based on the speed value of the first drive shaft and the speed value of the second drive shaft includes: computing a first torque difference between the first driven shaft and the first drive shaft; computing a second torque difference between the second driven shaft and the second drive shaft; obtaining an additional speed value of the first driven shaft and an additional speed value of the second driven shaft based on the first torque difference and the second torque difference; and obtaining the speed value of the first driven shaft and the speed value of the second driven shaft respectively based on the speed value of the first drive shaft, the speed value of the second drive shaft, the additional speed value of the first driven shaft, and the additional speed value of the second driven shaft. Based on comparison of an actual torque difference between the first driven shaft and the first drive shaft, and an actual torque difference between the second driven shaft and the second drive shaft, the actual torque difference between the first driven shaft and the first drive shaft, and the actual torque difference between the second driven shaft and the second drive shaft are processed by PID for use as the additional speed value of the first driven shaft and the additional speed value of the second driven shaft, thereby realizing the load balance between the first driven shaft and the first drive shaft, and between the second driven shaft and the second drive shaft, and realizing the load balance between either driven shaft and the corresponding drive shaft.

In some embodiments, the obtaining the additional speed value of the first driven shaft and the additional speed value of the second driven shaft based on the first torque difference and the second torque difference includes: adding a tension torque to the first torque difference or the second torque difference to obtain the additional speed value of the first driven shaft and the additional speed value of the second driven shaft. The tension torque is added to the first torque difference or the second torque difference, thereby realizing the effect of eliminating gear clearance when the rail-guided transport vehicle is stopped, and realizing precise positioning of the rail-guided transport vehicle.

In some embodiments, the rail-guided transport vehicle further includes a second group of drive control units identical to the first group of drive control units, and the method further includes: selecting the first group of drive control units or the second group of drive control units to perform drive control of the rail-guided transport vehicle. The first group of drive control units or the second group of drive control units are selected to perform drive control, and the second group of drive control units are used as backup of the first group of drive control units, thereby guaranteeing the system availability, and reducing the risks caused by failure of either group of the drive control units.

Some embodiments include a control device of a rail-guided transport vehicle including: a first group of drive control units, the first group of drive control units include: a first drive shaft and a first driven shaft corresponding to a first guide rail, and a second drive shaft and a second driven shaft corresponding to a second guide rail, and the first group of drive control units control the rail-guided transport vehicle based on the control method according to any one of the above solutions.

In some embodiments, the control device further includes: the second group of drive control units identical to the first group of drive control units, and the second group of drive control units are backup of the first group of drive control units.

Some embodiments include a rail-guided transport vehicle comprising: a first group of drive control units, the first group of drive control units include: a first drive shaft and a first driven shaft corresponding to a first guide rail, and a second drive shaft and a second driven shaft corresponding to a second guide rail, and the first group of drive control units control the rail-guided transport vehicle based on the control method according to any one of the above solutions.

In some embodiments, the control device further includes: the second group of drive control units identical to the first group of drive control units, and the second group of drive control units are backup of the first group of drive control units.

Some embodiments include a computer program product stored on a non-transitory readable medium fa controller, and includes computer executable instructions, where the computer executable instructions, when executed, cause at least one processor to execute one or more of the methods described herein.

Some embodiments include a non-transitory computer readable medium storing computer executable instructions thereon, where the computer executable instructions, when executed, cause at least one processor to execute one or more of the methods described herein.

To enable those skilled in the art to better understand the technical solutions of the present disclosure, various example embodiments of the present disclosure will be clearly and completely described below with reference to the accompanying drawings in the embodiments of the present disclosure. The described embodiments are merely a part, instead of all, of the embodiments of the present disclosure. All other embodiments obtained by those of ordinary skills in the art based on examples among the teachings of the present disclosure shall fall within the scope of protection of the present disclosure. Specific implementations of the embodiments of the present disclosure will be further described below with reference to the accompanying drawings in the embodiments of the present disclosure.

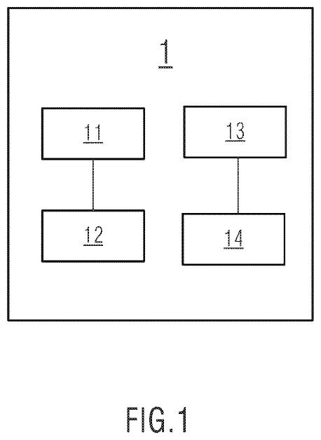

Referring to FIG. 1, the rail-guided transport vehicle includes a first group of drive control units 1. The first group of drive control units 1 includes: a first drive shaft 11 and a first driven shaft 12 corresponding to a first guide rail, and a second drive shaft 13 and a second driven shaft 14 corresponding to a second guide rail.

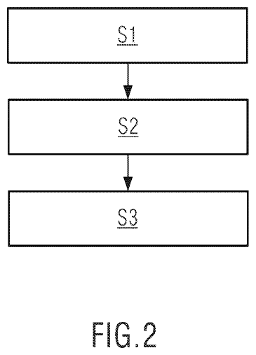

A control method of a rail-guided transport vehicle is shown in FIG. 2. The example method includes:

S1: setting the first drive shaft and the second drive shaft to synchronize their positions with a position of a virtual main axis of the first drive shaft and the second drive shaft.

S2: obtaining a third torque difference between the first drive shaft and the second drive shaft.

S3: rectifying, when the third torque difference is greater than a preset torque threshold, a deflection of the first drive shaft or the second drive shaft.

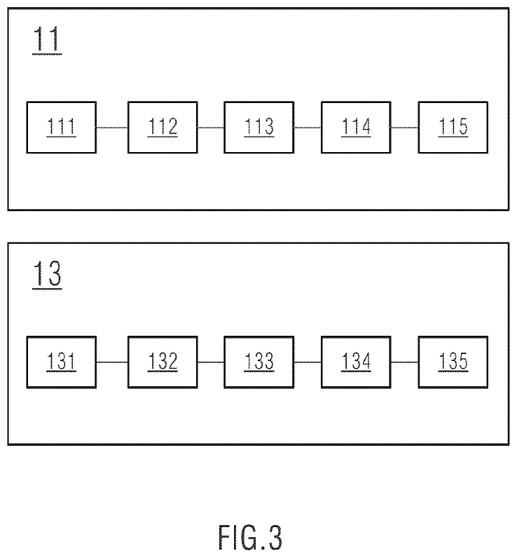

Referring to FIG. 3, a first drive shaft 11 moves under the drive of a first motor 115 controlled by a first position controller 111, a first speed controller 112, a first current controller 113, and a first converter 114. A second drive shaft 13 moves under the drive of a third motor 135 controlled by a third position controller 131, a third speed controller 132, a third current controller 133, and a third converter 134.

In some embodiments, the first drive shaft 11 and the second drive shaft 13 are set to synchronize their positions with a position of a virtual main axis of the first drive shaft 11 and the second drive shaft 13, to guarantee the accuracy of position synchronization between the first drive shaft 11 and the second drive shaft 13.

Since asynchronization between the first drive shaft 11 and the second drive shaft 13 will also cause the vehicle body deflection, the first drive shaft 11 and the second drive shaft 13 are set to synchronize their positions with the position of the virtual main axis, thereby reducing the vehicle body deflection caused by the poor position synchronization precision of the two drive shafts.

Specifically, when a sensor is used to measure whether there is a collision between a wheel of the vehicle body and a guide rail, a high failure rate will be caused by unadapting of the sensor for use in open air. Therefore, whether there is a collision between a wheel and a guide rail is determined based on a third torque difference between the first drive shaft 11 and the second drive shaft 13.

Due to uneven load arrangement on the rail-guided transport vehicle, there is the third torque difference between a drive torque outputted from the current controller 113 of the first drive shaft 11 and a drive torque outputted from the current controller 133 of the second drive shaft 13 on both sides of the guide rail. A maximum unbalanced load torque difference of the third torque difference is obtained through a test. When a collision occurs between the wheel and the guide rail, the third torque difference will increase significantly.

Only when the third torque difference between the first drive shaft 11 and the second drive shaft 13 is greater than the preset torque threshold, is the position of the first drive shaft 11 or the second drive shaft 13 rectified, thereby realizing the deflection rectification of the vehicle body. In this manner, erroneous deflection rectification resulted from the non-uniform distribution of loads is avoided.

In some embodiments, the operation S3 further includes: determining a direction for vehicle body deflection rectification based on a positive/negative value of the third torque difference.

For example, when the third torque difference between the first drive shaft 11 and the second drive shaft 13 has a positive value, the first drive shaft 11 has a larger torque, and the vehicle body deflects towards the direction of the first drive shaft 11; and, when the third torque difference between the first drive shaft 11 and the second drive shaft 13 is a negative value, the second drive shaft 13 has a larger torque, and the vehicle body deflects towards the direction of the second drive shaft 13. Whether the first drive shaft or the second drive shaft has a larger torque may be determined based on the positive/negative value of the third torque difference, thereby determining whether the direction for the vehicle body deflection rectification is towards the first drive shaft or the second drive shaft, and further improving the accuracy of the vehicle body deflection rectification.

In some embodiments, the preset torque threshold is obtained based on a variation curve of the third torque difference when the vehicle body of the rail-guided transport vehicle is not parallel to the first guide rail or the second guide rail. Specifically, the maximum unbalanced load torque difference is a maximum torque difference between the first drive shaft 11 and the second drive shaft 13 when loads are unevenly placed on the rail-guided transport vehicle. When the third torque difference is equal to or greater than the maximum unbalanced load torque difference, it means that the wheel collides with the guide rails, and deflection correction should be made. Otherwise, the vehicle cannot continue to travel normally. Therefore, the preset torque threshold should be much larger than the maximum unbalanced load torque difference.

The preset torque threshold is obtained based on the variation curve of the third torque difference when the vehicle body of the rail-guided transport vehicle is not parallel to the first guide rail or the second guide rail, such that the preset torque threshold can satisfy the deflection rectification of the vehicle body in time without frequent deflection rectification of the vehicle body.

In some embodiments, the operation S3 includes rectifying a position of the first drive shaft or the second drive shaft using a superimposed motion instruction, where the superimposed motion instruction is an instruction in a second coordinate system, and the second coordinate system is independent of a first coordinate system of the first drive shaft and the second drive shaft. Since the first drive shaft and the second drive shaft are synchronized with their virtual main axis in the first coordinate system, if the positions of the first drive shaft or the second drive shaft were adjusted in the first coordinate system, it would be considered as an interference by the system, and the first position controller and third position controller of the first drive shaft and the second drive shaft would automatically generate a slight reverse position adjustment to counteract the interference. Thus, it is not possible to realize the correction of deflection by adjusting the position in the first coordinate system. In order to address this problem, the position of the first drive shaft or the second drive shaft is rectified using the superimposed motion instruction in the second coordinate system independent of the first coordinate system of the first drive shaft and the second drive shaft in the embodiment of the present disclosure. The second coordinate system is independent of the first coordinate system, and will not interfere with a motion behavior in the first coordinate system.

In some embodiments, when the number of deflection rectifications performed in accordance with the superimposed motion instruction within a preset time interval exceeds a number threshold of deflection rectifications, a position rectification range corresponding to the superimposed motion instruction is decreased.

Since repeated deflection rectification of the vehicle body will cause the vehicle body deformation, in the embodiment of the present disclosure, when the number of deflection rectifications within the preset time interval exceeds the number threshold of deflection rectifications, the position rectification range corresponding to the superimposed motion instruction is decreased, thereby avoiding excessive deflection rectification caused by excessive position rectification range corresponding to the superimposed motion instruction. In other words, the position of the first drive shaft or the second drive shaft is slightly adjusted.

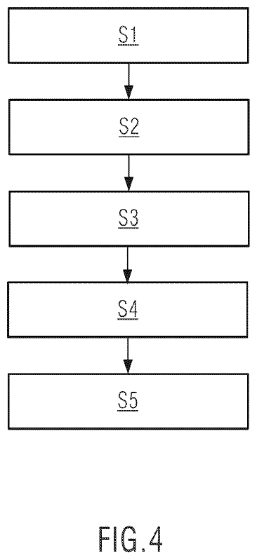

In some embodiments, referring to FIG. 4, the method further includes:

S4: configuring given position values of the first driven shaft and the second driven shaft as actual position values.

S5: setting a speed value of the first driven shaft and a speed value of the second driven shaft based on a speed value of the first drive shaft and a speed value of the second drive shaft.

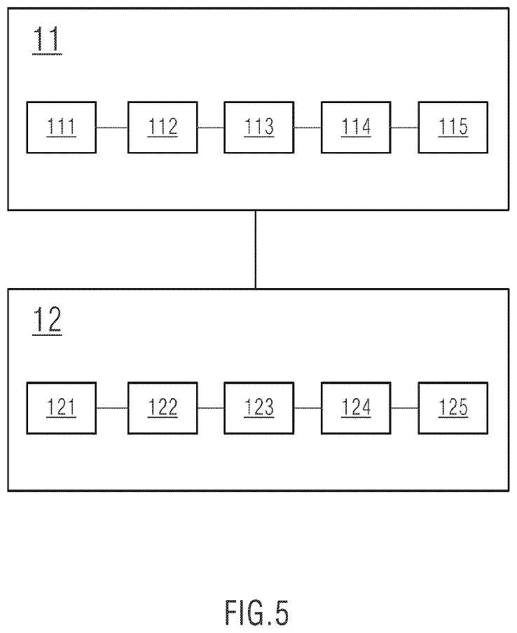

Specifically, referring to FIG. 5, the first drive shaft 11 and the first driven shaft 12 are taken as examples for description. The first drive shaft 11 moves under the drive of the first motor 115 controlled by the first position controller 111, the first speed controller 112, the first current controller 113, and the first converter 114. The first driven shaft 12 moves under the drive of a second motor 125 controlled by a second position controller 121, a second speed controller 122, a second current controller 123, and a second converter 124. Since a given position value of the second position controller 121 of the first driven shaft 12 is identical to its actual position value, the second position controller 121 actually does not work, and the first driven shaft is in a speed control mode. The second speed controller 122 of the first driven shaft 12 receives a speed value of the first drive shaft 11, and sets a speed of the first driven shaft 12 based on the speed value of the first drive shaft 11.

The control methods of the second drive shaft 13 and the second driven shaft 14 are the same as those of the first drive shaft 11 and the first driven shaft 12, and thus the description will not be repeated here.

The actual position values of the first driven shaft and the second driven shaft are configured as their set position values so that the position controllers of the first driven shaft and the second driven shaft actually do not work. Thus, the first driven shaft and the second driven shaft operate in a speed control mode. The set speed values of the first driven shaft and the second driven shaft may be the set speed values of the first drive shaft and the second drive shaft respectively.

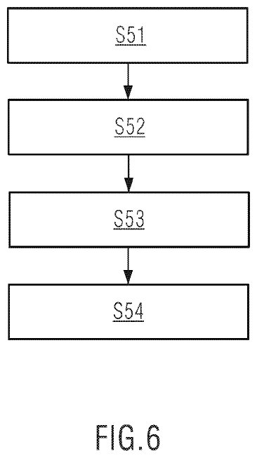

In some embodiments, referring to FIG. 6, the step S5 includes:

S51: computing a first torque difference between the first driven shaft and the first drive shaft.

S52: computing a second torque difference between the second driven shaft and the second drive shaft.

S53: obtaining an additional speed value of the first driven shaft and an additional speed value of the second driven shaft based on the first torque difference and the second torque difference.

S54: obtaining the speed value of the first driven shaft and the speed value of the second driven shaft respectively based on the speed value of the first drive shaft, the speed value of the second drive shaft, the additional speed value of the first driven shaft, and the additional speed value of the second driven shaft.

The load balance between the first driven shaft and the first drive shaft, and between the second driven shaft and the second drive shaft is achieved with the additional speed values of the first driven shaft and the second driven shaft which is based on the actual torque difference between the first driven shaft and the first drive shaft and the actual torque difference between the second driven shaft and the second drive shaft, and processed by PID.

In some embodiments, the operation S53 includes adding a tension torque to the first torque difference or the second torque difference to obtain the additional speed value of the first driven shaft and the additional speed value of the second driven shaft. The tension torque is added to the first torque difference or the second torque difference, thereby realizing the effect of eliminating gear clearance when the rail-guided transport vehicle is stopped and realizing precise positioning of the transport vehicle.

In some embodiments, the rail-guided transport vehicle further includes a second group of drive control units identical to the first group of drive control units, and the method further includes: selecting the first group of drive control units or the second group of drive control units to perform drive control. The first group of drive control units or the second group of drive control units are selected to perform drive control, and the second group of drive control units are used as backup of the first group of drive control units, £ thereby guaranteeing the system availability, and reducing the risks caused by failure of either group of drive control units.

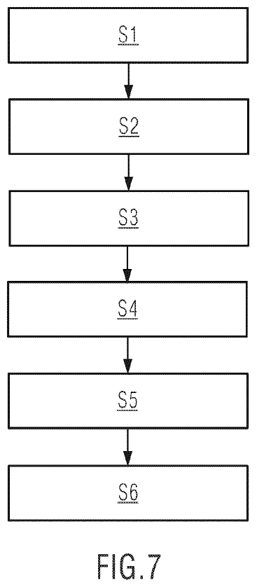

In some embodiments, the rail-guided transport vehicle further includes a second group of drive control units identical to the first group of drive control units, and referring to FIG. 7, the method further includes S6: selecting the first group of drive control units or the second group of drive control units to perform drive control. The first group of drive control units or the second group of drive control units are selected to perform drive control, and the second group of drive control units are used as backup of the first group of drive control units, thereby guaranteeing the system availability, and reducing the risks caused by failure of either group of drive control units.

Some embodiments include a control device of a rail-guided transport vehicle including: a first group of drive control units, the first group of drive control units include: a first drive shaft and a first driven shaft corresponding to a first guide rail, and a second drive shaft and a second driven shaft corresponding to a second guide rail, and the first group of drive control units control the rail-guided transport vehicle based on the control method according to any one of the above solutions.

In some embodiments, the control device further includes: the second group of drive control units identical to the first group of drive control units, and the second group of drive control units are backup of the first group of drive control units. The first group of drive control units or the second group of drive control units are selected to perform drive control, and the second group of drive control units are used as backup of the first group of drive control units, thereby guaranteeing the system availability, and reducing the risks caused by failure of either group of drive control units.

Some embodiments include a rail-guided transport vehicle having: a first group of drive control units, the first group of drive control units include: a first drive shaft and a first driven shaft corresponding to a first guide rail, and a second drive shaft and a second driven shaft corresponding to a second guide rail, and the first group of drive control units control the rail-guided transport vehicle based on the control method according to any one of the above solutions.

In some embodiments, the rail-guided transport vehicle further includes the second group of drive control units identical to the first group of drive control units, and the second group of drive control units are backup of the first group of drive control units. The first group of drive control units or the second group of drive control units are selected to perform drive control, and the second group of drive control units are used as backup of the first group of drive control units, thereby guaranteeing the system availability, and reducing the risks caused by failure of either group of drive control units.

Some embodiments include a computer program product stored on a tangible, non-transitory readable medium of a controller, and includes computer executable instructions, where the computer executable instructions, when executed, cause at least one processor to execute one or more of the methods of the above solutions.

Some embodiments include a tangible, non-transitory computer readable storage medium storing computer executable instructions thereon, where the computer executable instructions, when executed, cause at least one processor to execute one or more of the methods of the above solutions.

It should be noted that, depending on the implementation requirements, the components/steps described in the embodiments of the present disclosure may be split into more components/steps, or two or more components/steps or partial operations of the components/steps may be combined into novel components/steps to achieve the goal of the embodiments of the present disclosure.

The above methods may be implemented in hardware or firmware, or be implemented as software or computer code storable in a recording medium (such as a CD ROM, RAM, floppy disk, hard disk, or magnetic disk), or be implemented as computer code that is downloaded from a network, is originally stored in a remote recording medium or a non-transitory machine-readable medium, and will be stored in a local recording medium, such that the method described herein may be processed by such software stored on a recording medium using a general-purpose computer, a special-purpose processor, or programmable or dedicated hardware (such as an ASIC or FPGA). It is understandable that a computer, processor, microprocessor controller, or programmable hardware includes a storage component (e.g., RAM, ROM, or flash memory) that can store or receive software or computer code. The method for generating check code described herein is implemented when the software or computer code is accessed and executed by the computer, processor, or hardware. Further, when a general-purpose computer accesses the code for implementing the method for generating check code shown herein, the execution of the code converts the general-purpose computer to a special-purpose computer configured to execute the method for generating check code shown herein.

As will be appreciated by those of ordinary skills in the art, the various example units and method steps described in combination with the embodiments disclosed herein can be implemented by electronic hardware, or a combination of computer software and electronic hardware. Whether these functions are performed by hardware or software depends on specific applications and design constraints of the technical solutions. Those skilled in the art may implement described functions for each specific application using different methods, but such implementation should not be considered as falling beyond the scope of the present disclosure.

The above implementations are only used to illustrate selected example embodiments of the present disclosure and are not intended to limit the present disclosure. Those of ordinary skills in the relevant technical field may further make various alterations and modifications without departing from the spirit and scope of the embodiments of the present disclosure. Therefore, all equivalent technical solutions also belong to the scope of the embodiments of the present disclosure, and the scope of patent protection of the embodiments of the present disclosure should be defined by the appended claims.

What is claimed is:

1. A control method for a rail-guided transport vehicle with a first group of drive control units including a first drive shaft and a first driven shaft corresponding to a first guide rail, and a second drive shaft and a second driven shaft corresponding to a second guide rail, the method comprising:
setting the first drive shaft and the second drive shaft to synchronize their positions with a position of a virtual main axis of the first drive shaft and the second drive shaft;
obtaining a third torque difference between the first drive shaft and the second drive shaft; and
rectifying, when the third torque difference is greater than a preset torque threshold, a deflection of the first drive Shaft or the second drive shaft.

2. The method according to claim 1, wherein the rectifying, the deflection of the first drive shaft or the second drive shaft comprises
determining a direction for deflection rectification based on a positive/negative value of the third torque difference.

3. The method according to claim 2, wherein the preset torque threshold is based on a variation curve of the third torque difference when a vehicle body of the rail-guided transport vehicle is not parallel to the first guide rail or the second guide rail.

4. The method according to claim 1, wherein:
rectifying the deflection of the first drive shaft or the second drive shaft comprises
rectifying the position of the first drive shaft or the second drive shaft using a superimposed motion instruction, wherein the superimposed motion instruction is an instruction in a second coordinate system; and
the second coordinate system is independent of a first coordinate system of the first drive shaft and the second drive shaft.

5. The method according to claim 4, further comprising when the number of deflection rectifications performed in accordance with the superimposed motion instruction within a preset time interval exceeds a number threshold of deflection rectifications, decreasing a position rectification range corresponding to the superimposed motion instruction.

6. The method according to claim 1, further comprising:
configuring the actual position values of the first driven shaft and the second driven shaft as their set position values; and
setting a speed value of the first driven shaft and a speed value of the second driven shaft based on a speed value of the first drive shaft and a speed value of the second drive shaft.

7. The method according to claim 6, wherein setting the speed value of the first driven shaft and the speed value of the second driven shaft based on the speed value of the first drive shaft and the speed value of the second drive shaft comprises:
computing a first torque difference between the first driven shaft and the first drive shaft;
computing a second torque difference between the second driven shaft and the second drive shaft;
obtaining an additional speed value of the first driven shaft and an additional speed value of the second driven shaft based on the first torque difference and the second torque difference; and
obtaining the speed value of the first driven shaft and the speed value of the second driven shaft respectively based on the speed value of the first drive shaft, the speed value of the second drive shaft, the additional speed value of the first driven shaft, and the additional speed value of the second driven shaft.

8. The method according to claim 7, wherein obtaining the additional speed value of the first driven shaft and the additional speed value of the second driven shaft based on the first torque difference and the second torque difference comprises
adding a tension torque to the first torque difference or the second torque difference to obtain the additional speed value of the first driven shaft and the additional speed value of the second driven shaft.

9. The method according to claim 1, wherein:
the rail-guided transport vehicle further comprises a second group of drive control units identical to the first group of drive control units; and
the method further comprises
selecting the first group of drive control units or the second group of drive control units to perform drive control of the rail-guided transport vehicle.

10. A control device for a rail-guided transport vehicle, the device comprising:
a first group of drive control units including a first drive shaft and a first driven shaft corresponding to a first guide rail, and a second drive shaft and a second driven shaft corresponding to a second guide rail,
wherein the first group of drive control units operates to:
set the first drive shaft and the second drive shaft to synchronize their positions with a position of a virtual main axis of the first drive shaft and the second drive shaft;
obtain a third torque difference between the first drive shaft and the second drive shaft; and
rectify, when the third torque difference is greater than a preset torque threshold, a deflection of the first drive shaft or the second drive shaft.

11. The control device according to claim 10, wherein the control device further comprises, a second group of drive control units identical to the first group of drive control units, and the second group of drive control units are backup of the first group of drive control units.

12. A rail-guided transport vehicle, comprising:
a first group of drive control units comprising: a first drive shaft and a first driven shaft corresponding to a first guide rail, and a second drive shaft and a second driven shaft corresponding to a second guide rail;
wherein the first group of drive control units operates to:
set the first drive shaft and the second drive shaft to synchronize their positions with a position of a virtual main axis of the first drive shaft and the second drive shaft;
obtain a third torque difference between the first drive shaft and the second drive shaft; and
rectify, when the third torque difference is greater than a preset torque threshold, a deflection of the first drive shaft or the second drive shaft.

13. The rail-guided transport vehicle according to claim 12, further comprising a second group of drive control units identical to the first group of drive control units, and the second group of drive control units are backup of the first group of drive control units.

14-15. (canceled)
